(19) United States
(12) Patent Application Publication
(10) Pub. No.: US 2024/0006785 A1
(43) Pub. Date: Jan. 4, 2024

(54) Battery Connector

(71) Applicant: Barry Joseph Murchie, Long Beach, NSW (AU)

(72) Inventor: Barry Joseph Murchie, Long Beach, NSW (AU)

(21) Appl. No.: 18/252,371

(22) PCT Filed: Nov. 22, 2021
(86) PCT No.: PCT/AU2021/051389

§ 371 Date: May 10, 2023

(51) Int. Cl. H01R 11/28; H01R 4/48

(52) U.S. Cl. CPC H01R 11/283; H01R 11/284; H01R 4/48; H01M 2220/20; H01M 50/543

(57) ABSTRACT

A battery connector for a battery having a terminal post, the battery connector including a main body with a terminal clamp end and a lead end, the battery connector further comprising: a clamp body including: a conductive body for conducting charge from the lead end to the terminal clamp end; a lead mount disposed at the lead end for mounting a lead; an arcuate wall which provides a battery terminal post aperture for receiving the terminal post; a substantially insulating clamp actuator; an adjuster including first and second cooperating ramps, the first ramp mounted on the arcuate wall and the second ramp mounted on the clamp actuator, at least one ramp or flange being movable between a wide position and a narrow position, wherein the clamp actuator is configured to cooperate with the clamp body to close the arcuate wall around the terminal post by a relative movement between the insulating clamp actuator and the clamp body. The battery connector also provides a lead mounting zone at the lead end and a lead end closure for controlling access to the auxiliary lead end for connecting and disconnecting the one or more auxiliary leads without disconnecting the connector from the terminal post.

### TECHNICAL FIELD

The present technology relates generally to a battery connector for connecting one or more electric leads to a battery terminal post.

### BACKGROUND

The use of battery connectors to attach leads to a battery terminal is known. For example, battery connectors are found in cars, boats, caravans, trucks, tractors, trains, locomotives, trailers, campervans and other vehicles.

One disadvantage of such connectors is that they cannot be readily adjusted for different diameter battery terminals. Hence, typically, different-sized connectors are required for different battery post dimensions. Having such connectors of different sizes and configurations is costly and inefficient.

Further, having many different connector types requires the user to learn numerous securing methods during installation, which is time consuming.

In addition, it is useful to provide safety when dealing with live batteries. The risks of an injurious electrical failure, or an “arc up” as it is colloquially known in the field, is real. This poses a risk to the health of the user, along with a possible electrical burnout risk to other electrical components.

Battery terminal post connectors are largely slow to connect and release from the terminal post. They can also be insecure in their connection to the terminal post, which leads to arcing and power loss.

Also, attachment of an auxiliary lead can be difficult and slow, or the access can be un-ergonomic.

The present technology seeks to provide a connector that substantially ameliorates one or more of the abovementioned disadvantages.

### SUMMARY

Throughout this specification and the claims that follow, the phrase “automotive battery” is to be considered as encompassing many kinds of rechargeable battery for use in heavy applications such as for example automotive, marine, agricultural, trucking, mining and the like. The type of battery could include lead-acid, AGM, lithium-ion, gel, sealed, VRLA, SLA, deep cycle and the like. The batteries may be 12V, 24V, 48V, and like potentials, with capacities of 50-100+Ah, and/or 1000 CCA or similar specification.

In accordance with one aspect of the present technology there is provided a battery connector for a battery having a terminal post, the battery connector including a main body with a terminal post clamp end and a lead end, the battery connector further comprising:
a clamp body including:
   a conductive body for conducting charge from the lead end to the terminal post clamp end;
   a lead mount disposed at the lead end for mounting one or more leads;
   an arcuate wall which provides a battery terminal post aperture for receiving the terminal post;
a substantially insulating clamp actuator; and
an adjuster including first and second cooperating ramps, the first ramp mounted on the arcuate wall and the second ramp mounted on the clamp actuator, at least one ramp being movable between a wide position and a narrow position,
   wherein the insulating clamp actuator is configured to cooperate with the clamp body to close the arcuate wall around the terminal post by a relative movement between the insulating clamp actuator and the clamp body which drives the ramps into abutment with one another.

In accordance with another aspect of the present technology there is provided a battery connector for connecting a lead to a terminal post of an automotive battery, the battery connector including:
a connector body including a terminal end and a lead end, the connector body including:
   a clamp at the terminal end for clamping to the terminal post, the clamp including a conductive arcuate wall to provide a terminal post aperture adjustable in size for clamping substantially around the terminal post,
   an auxiliary lead mounting zone disposed at the lead end for mounting at least one auxiliary lead,
wherein there is a lead end closure for controlling access to the auxiliary lead end for connecting and disconnecting the at least one auxiliary lead.

In one embodiment there is provided an adjuster for adjusting the size of the terminal post aperture.

In one embodiment the adjuster includes an adjustment leg extending from a portion of the arcuate wall, the adjustment leg movable between a narrow position in which the terminal post aperture is smaller to clamp the arcuate peripheral wall snugly against small diameter terminal posts, to a wide position in which the terminal post aperture is larger such that the arcuate wall clamps snugly against larger diameter terminal posts.

In one embodiment the arcuate wall and adjustment leg is biased to the wide position.

In one embodiment the adjuster further includes an adjustment arm which is movable between a wide position and a narrow position to adjust the arcuate wall to clamp onto a range of large diameter and small diameter terminal posts.

The arrangement is such that upon moving the insulating actuator relative to the clamp body such that they interengage with one another, the insulating actuator and clamp body are releasably secured against each other.

In one embodiment the adjuster ramps are disposed on adjustment flanges, adjustment legs or adjustment arms, wherein the first adjustment flange, leg, or arm includes a ramp surface which is configured to abut against with a ramp surface of the cooperating adjustment flange, leg or arm, when the adjustment arm pushes against the adjustment leg to reduce the size of the battery terminal aperture and tighten the clamp body against the terminal post when in the closed position.

The arrangement of some embodiments is such that the variation of the offset movement by adjustment of the adjuster varies the amount of bias of the adjustment arm against the adjustment leg to allow the connector to attach to a range of terminal posts of different diameters.

In one embodiment the adjuster ramps are in the form of adjustment arms.

In one embodiment the adjuster ramps are in the form of an adjustment leg.

In one embodiment there is provided an adjuster to vary an inward movement of the adjustment arm.

In one embodiment the clamp actuator is an insulating cover to inhibit contact with the terminal and lead and conducting body.

In one embodiment the insulating cover is fastened to an end of the clamp nearest the input aperture to allow the insulating cover to pivot between an open position and a closed position.

In one embodiment the lead mount includes an input aperture for receiving the lead.

In one embodiment the lead mount further includes a securing means for securing the lead in the input aperture.

In one embodiment the arrangement is such that the conductive body is connected to the input aperture and is electrically contactable with the lead when the lead is secured in the input aperture.

In one embodiment the insulating cover is releasably secured to the inner clamp by: the inner clamp comprising a notch at an end proximal to the battery terminal post aperture; and the insulating cover comprising a corresponding space for engaging with the notch; wherein, upon pivoting to the closed position, the insulating cover is releasably secured to the inner clamp by the notch engaging the corresponding space of the insulating cover.

In one embodiment the clamp body comprises a conductive material.

In one embodiment the conductive portion is a conductive inner sleeve of the inner clamp.

In one embodiment the adjustment means is an adjusting screw.

In one embodiment the securing means is a threaded bolt with a tightening section.

In one embodiment the auxiliary connection means is affixed to a base of the tightening section of the threaded bolt.

In one embodiment the auxiliary connection means comprises an auxiliary bolt and a corresponding nut for tightening.

In one embodiment the auxiliary bolt and nut are a smaller diameter than the threaded bolt with the tightening section.

In one embodiment the insulating cover further comprises a lip on an exterior side, configured to be gripped by a user to move the insulating cover between the open and closed positions.

A kit for connecting a lead to a battery terminal comprising: a battery connector as herein described; a lead affixed to the battery connector; and the lead at the opposite end having an electrical attachment means affixed thereto.

In one embodiment the electrical attachment means is also a battery connector as herein described.

In one embodiment the adjustment screw includes a thumb actuator to allow for toolless inward or outward adjustment of the adjustment arm.

In one embodiment there is provided a port or shoulder on or in the clamp actuator for facilitating lifting of the clamp actuator or clamp cover from the clamp body with a screwdriver or tool.

In one embodiment the clamp actuator is detachable from the clamp body to provide a quick release.

In one embodiment the kit includes at least two battery connectors as herein described; a lead affixed to each one of the battery connectors; and each lead at the opposite end having an electrical attachment means affixed thereto.

In one embodiment each of the electrical attachment means are also battery connectors as herein described.

A battery connector for a battery terminal having a terminal post, comprising: an inner clamp including:
a conductive portion;
an input aperture for receiving a lead;
a securing means for securing the lead in the input aperture;
an adjustment leg;
a battery terminal post aperture for receiving the terminal post; and wherein the conductive portion is connected to the input aperture and is electrically contactable with the lead when the lead is secured in the input aperture;
a insulating cover including:
an adjustment arm;
and an adjustment means to vary an offset movement of the adjustment arm;
wherein the insulating cover is joined to an end of the inner clamp nearest the input aperture to allow the insulating cover to pivot between an open position and a closed position;
wherein upon closing the insulating cover over the inner clamp, the insulating cover and inner clamp are releasably secured against each other, and the adjustment leg is adapted to interact with the adjustment arm through the adjustment arm biasing against the adjustment leg to shrink the battery terminal aperture and tighten the inner clamp against the terminal post when in a closed position; and
wherein the variation of the offset movement by adjustment of the adjustment means varies the amount of bias of the adjustment arm against the adjustment leg to allow the connector to attach to terminal posts of varying diameters.

### BRIEF DESCRIPTION OF THE DRAWINGS

To enable a clearer understanding, embodiments of the present technology will hereinafter be described with reference to the attached drawings, and in those drawings:

FIG. 1 illustrates a battery connector according to an embodiment of the present technology;

FIG. 2 illustrates the battery connector of FIG. 1 in an exploded view showing its components;

FIG. 3a illustrates a plan view of the clamp body of the battery connector of FIG. 1;

FIG. 3b illustrates a bottom view of the clamp body of the battery connector of FIG. 1;

FIG. 4a illustrates a plan view of the battery connector of FIG. 1;

FIG. 4b illustrates a bottom view of the battery connector of FIG. 1;

FIG. 5 illustrates the battery connector of FIG. 1 with the clamp actuator partially open to show the adjuster which includes the first and second cooperating adjustment ramps, one of which is movable by a screw;

FIG. 6 illustrates a perspective view of the battery connector of FIGS. 1 and 5 with the clamp actuator partially open, again, showing the cooperating adjustment ramps, one of which is movable to provide an adjustable terminal post aperture, for fitment to terminal posts of different diameters;

FIG. 7a illustrates a rear view of the battery connector of FIG. 1;

FIG. 7b illustrates a front perspective view of the battery connector of FIG. 1 with the clamp actuator partially open;

FIG. 8 illustrates the clamp body of the battery connector of FIG. 1;

FIG. 9 illustrates an alternative embodiment of the clamp showing the alternative use of a conductive inner sleeve;

FIG. 10a illustrates a top view of the alternative embodiment of the inner clamp of the battery connector with a conductive inner sleeve;

FIG. 10b illustrates a bottom view of the alternative embodiment of the inner clamp of FIG. 10a;

FIG. 11 illustrates a conductive inner sleeve of an embodiment of the present technology;

FIG. 12 illustrates an exploded view of the battery connector with a conductive inner sleeve in situ in the inner clamp;

FIG. 13 is an isometric view of another embodiment of a quick release battery connector in situ on a battery terminal. The quick release battery connector includes an access closure which controls access to an auxiliary terminal mount, the access closure being in a closed position. The quick release battery connector also includes a clamp actuator which is shown in an open position, in which it is hinged upwardly;

FIG. 14 is a different isometric view of the battery connector of FIG. 13, the view being from above and in front with the quick release clamp actuator being in an open position and showing an adjustment arm and an adjustment leg;

FIG. 15 is a side perspective view of the battery connector of FIG. 13;

FIG. 16 is a side perspective view of the battery connector of FIG. 13, but with the clamp actuator and access closure being in closed positions;

FIG. 17 is a rear perspective view of the battery connector of FIG. 13, with the quick release clamp being in a closed position to clamp the connector to the terminal, and the access closure being in an open position to access the auxiliary terminal mount; and

FIG. 18 is a side perspective view of FIG. 17 to highlight the thumb screw adjuster for the clamp.

### DETAILED DESCRIPTION OF AN EMBODIMENT

### Embodiment One

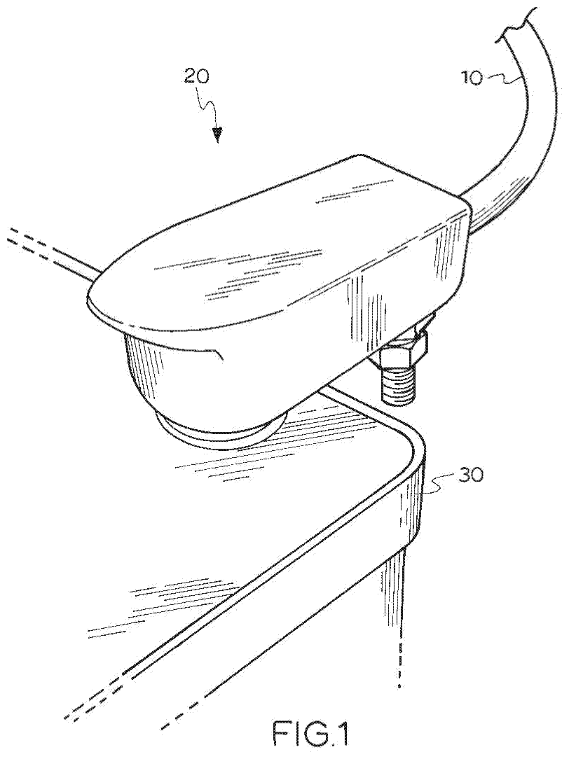

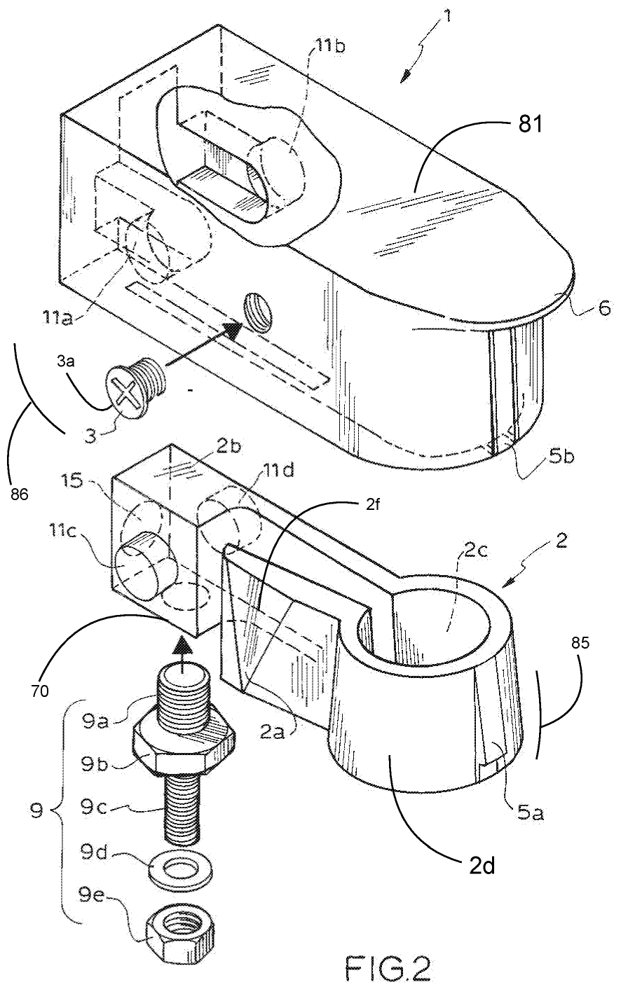

FIGS. 1 and 2 illustrate a battery connector (20) for connecting an electrical lead (10) to a battery (30) according to an embodiment of the present technology. There are two major assemblies: a quick clamp actuator (1), and a clamp body (2).

When assembled, the quick clamp actuator (1) is pivotally attached to the clamp body (2). This allows for ready securing of, and readily-releasable securing of, the connector (20) to a terminal post (not shown) of a battery (30) once the clamp (2) is placed upon the terminal post. Plastic hinges or other electrically inert hinges and the like are suitable for this purpose.

The quick clamp actuator (1) is in the form of a substantially insulating cover (81) and includes two cylindrical apertures (11a, 11b), one on either side of the insulating cover (81). These cylindrical apertures (11a, 11b) each accept two slightly smaller cylindrical bosses (11c, 11d) which form part of the clamp (2), and when the cylindrical apertures (11a, 11b) engage the cylindrical bosses (11c, 11d), they act as a pivot. This in turn allows the insulating cover (81) to move from a closed position covering the clamp body (2) to an open position, wherein the clamp (2) is exposed, and its grip on the terminal post is released as described below.

The connector (20) includes a terminal end (85) for connecting to the terminal post and a lead end (86) for connecting one or more leads (10) and (51). On the terminal end of the cover is snap female lock element (5b) designed to snap closed and lock the insulating cover (81) in the closed position over with the clamp (2) which has a correspondingly designed and closely fitted snap lock male section (5a).

Above the snap female lock element (5b) is an extended lip (6) to assist the user in gripping the insulating cover (81) when intending to open the insulating cover (81) and disengage the connector (20).

Referring now to FIGS. 2, 4b, 5 and 6, along one side of the insulating cover (81) is an adjuster (3), which is an assembly which includes an adjustment screw (3a) and one or more movable ramps in the form of adjustment arm (4) and adjustment leg (2a). The adjustment screw (3a) is optionally a screw, screwable through a hole in the side of the insulating cover (81), as shown in FIG. 2. The adjustment screw (3) engages with the adjusting arm (4) of the insulating cover (81) to move it between a wide position and a narrow position discussed in more detail below.

A lead-in (2f, 102f) is provided to allow a tolerance in the fitment of the sliding of the ramps past one another.

On an inner face of the insulating cover (81) and adjacent to the adjuster (3) is the adjustment arm (4) which is a ramp or a flange (4a). When screwed in or out, the adjustment screw (3a) will vary a closing diameter of an arcuate wall (2d) of the clamp (2) to enable the clamp (2) to be attached to a variety of different diameter battery terminal posts as described below. Different battery terminals have different diameter terminal posts, and therefore this feature allows the battery connector to be used with a variety of battery terminal posts of different sizes.

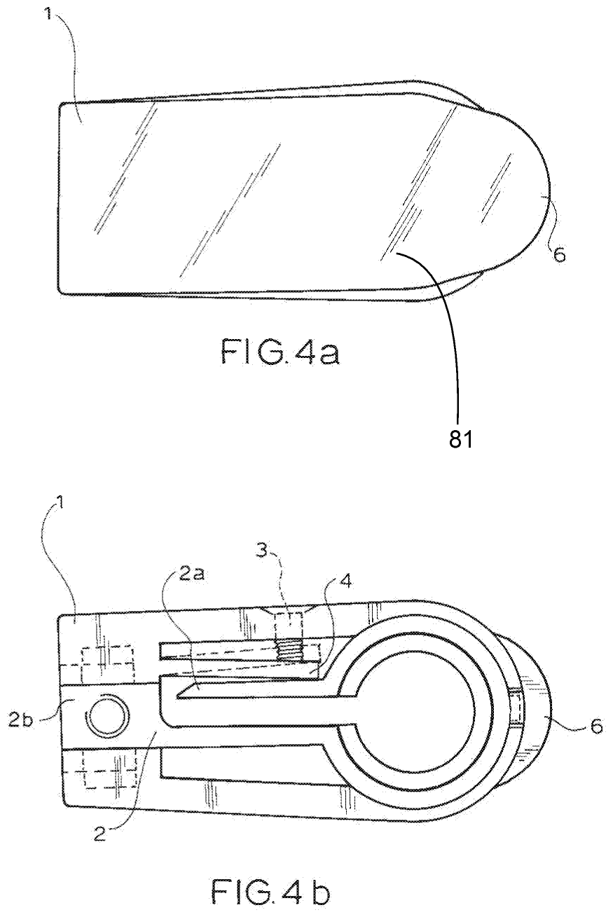

The adjustment arm (4) is used to bias against and engage with the adjustment leg (2a) of the clamp (2). The clamp (2) further comprises an aperture (2c) for receiving the battery terminal post. The biasing of the adjusting arm (4) against the adjustment leg (2a) reduces the diameter of the terminal post aperture (2c) as the insulating cover (1) is moved to the closed position over the clamp (2), hence tightly fitting the clamp (2) over the terminal post. The diameter of the terminal post aperture provided by the arcuate wall (2d) of the clamp (2) is set by varying the depth of the adjustment screw (3a), and as a result, the adjustment arm (4) has an inward movement from its original position in the insulating cover (1). This inward movement is the amount of deflection of the adjustment arm (4) from its natural rest position (See FIG. 4b in particular).

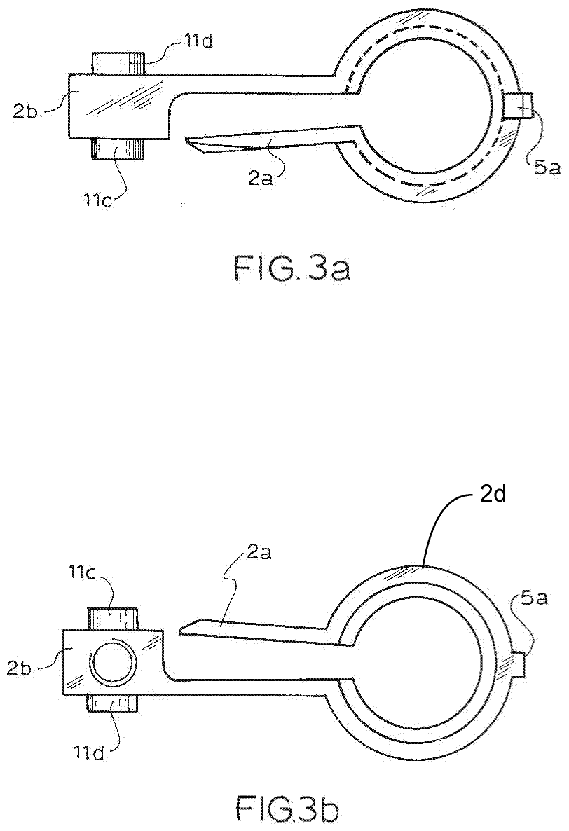

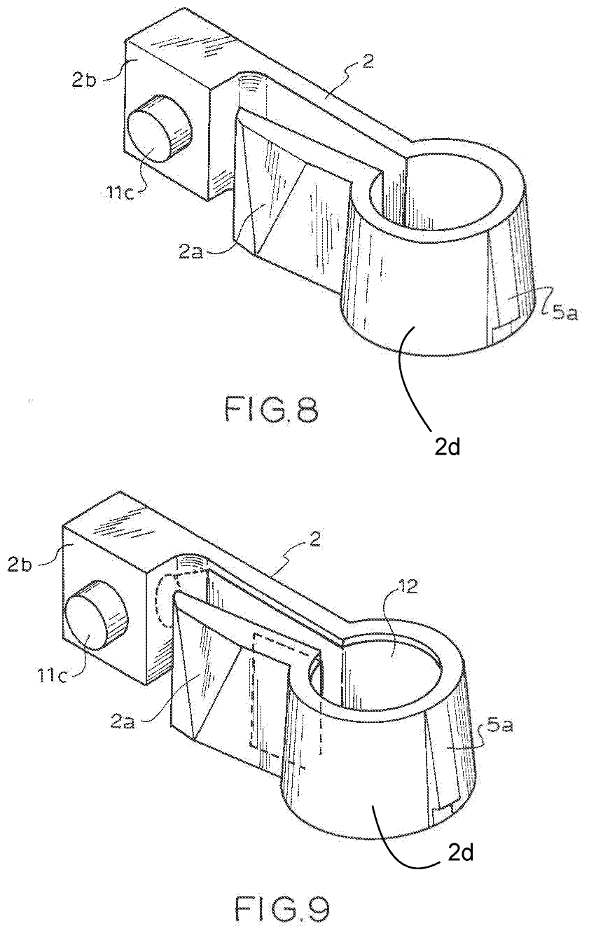

Referring now to FIGS. 2, 3a, 3b, 6, 7a, and 8, the clamp (2) includes a conductive arcuate wall (2d) for providing a terminal post aperture (2c) adjustable in size for clamping substantially around the terminal post. The clamp includes end (2b) proximal to an input aperture (15) for receiving the lead (10), and at the other end, the terminal post aperture (2c) proximal to the snap lock male section (5a). The inner clamp (2) may be comprised entirely of a conductive material such as copper, brass, and other electrically conductive materials known to those skilled in the art.

On the underside of the end (2b) proximal to the input aperture (15) is a lead mounting zone (70) including a securing means (9) for securing the lead (10) to the battery connector.

As shown in FIG. 2, the securing means (9) is a clamping post comprising a threaded bolt (9a) and tightening section (9b). The securing means (9) can alternatively take the form of a fitted stud, peg, or the like. When in place, the lead (not shown) will be held in position by means of the securing means (9) threaded through the end (2b) proximal to the input aperture and securely fastened in place by twisting the tightening section (9b) of the threaded bolt (9a) with a spanner or like tool. This in turn closes off the input aperture (15) and clamps onto the lead thereby pressing the lead to the underside of the clamp body (2).

The securing means (9) can also include a threaded section (9c, 9d, 9e) for attaching other auxiliary smaller cables to power auxiliary devices such as extra driving lights on a vehicle.

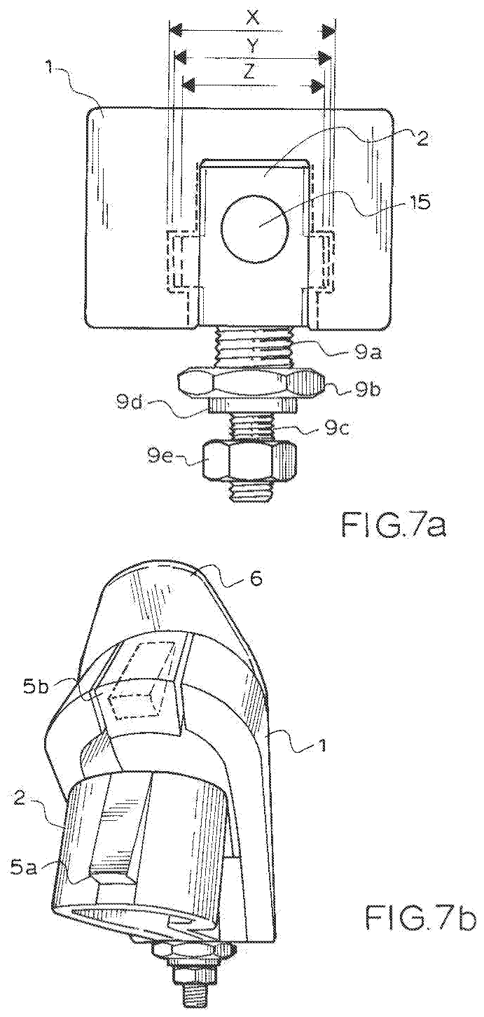

Referring now to FIGS. 2 and 7a, as previously discussed above, there are two cylindrical bosses (11c, 11d), one boss being on either side of the end (2b) proximal to the input aperture (15). The bosses are designed to slot into the accepting and closely fitted cylindrical apertures (11a, 11b) of the insulating cover (1) to act as a pivot point between the insulating cover (81) and the clamp body (2).

The end proximal to the battery terminal post aperture (2c) includes the snap lock male section (5a) integrally formed as part of the inner clamp (2). The snap lock male section (5a) is shaped and designed to be closely fitted with the snap lock female section (5b) correspondingly located on the insulating cover (81) as discussed above. This forms a releasable lock, holding the insulating cover (81) and clamp body (2) in a locked and secure position when engaged.

The three widths shown in FIG. 7a relate to how the cylindrical bosses (11c, 11d) slot into the cylindrical cavities (11a, 11b). The width X is the distance between the ends of the cylindrical cavities (11a, 11b). The width Y is the distance between the ends of the cylindrical bosses (11c, 11d) and is less than width X. The width Z is the distance of the edges of two slot channels (not shown) in the insulating cover (81) and is less than distance Y. During assembly of the battery connector, the cylindrical bosses (11c, 11d) are urged through the channels to slot into the cylindrical cavities (11a, 11b). These widths ensure that the cylindrical bosses are securely retained into the cylindrical cavities.

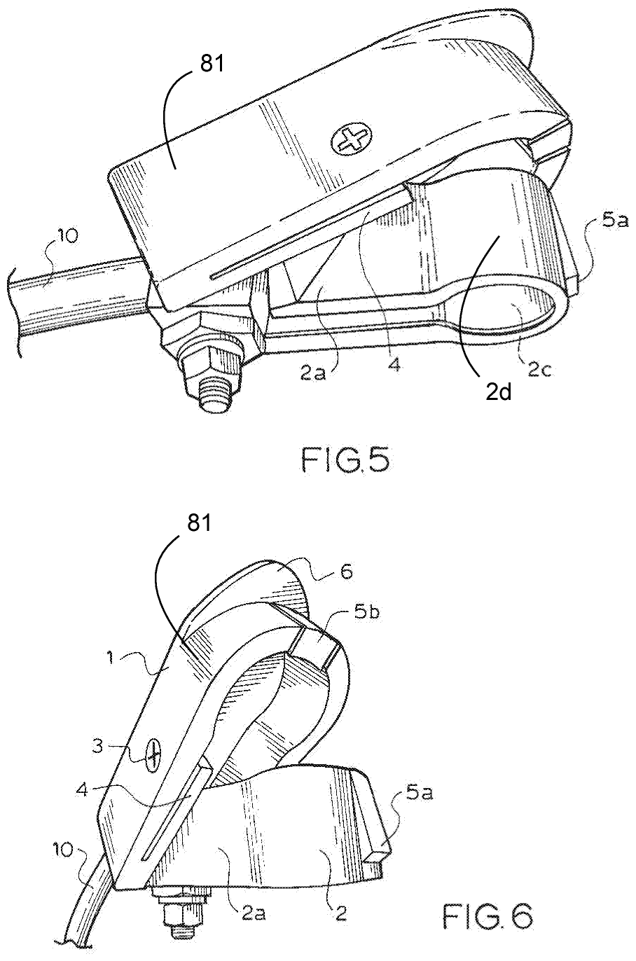

FIGS. 5 and 6 show the insulating cover in a partially open state, spaced from the clamp body (2), with both snap lock male (5a) and snap lock female (5b) sections visible.

The portion of the clamp body (2) forming the battery terminal post aperture (2c) is tapered to fit closely with and over the battery terminal post and is closed off or reduced in diameter as the battery connector is closed. The adjustment leg (2a) is bevelled and shaped to abut the adjustment arm (4) of the insulating cover (81) such that when the insulating cover (81) is lowered, the adjustment leg (2a) engages with the adjustment arm (4) and begins to close off the terminal post aperture (2c) in order to tighten about a battery post terminal.

FIG. 7b shows a front perspective view of the battery connector and the relationship between the snap lock male section (5a) and snap lock female section (5b). The snap lock sections are made of the same material and integral with the respective insulating cover (81) and clamp body (2) on which they are formed.

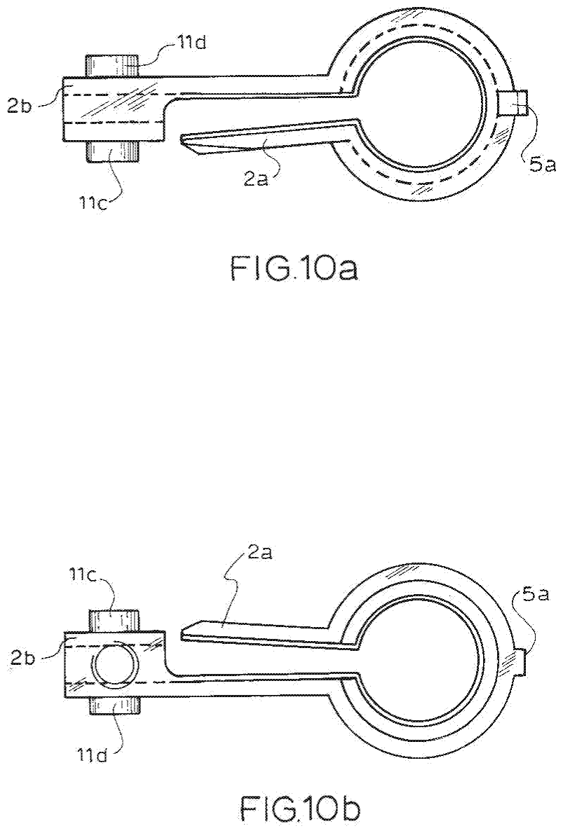

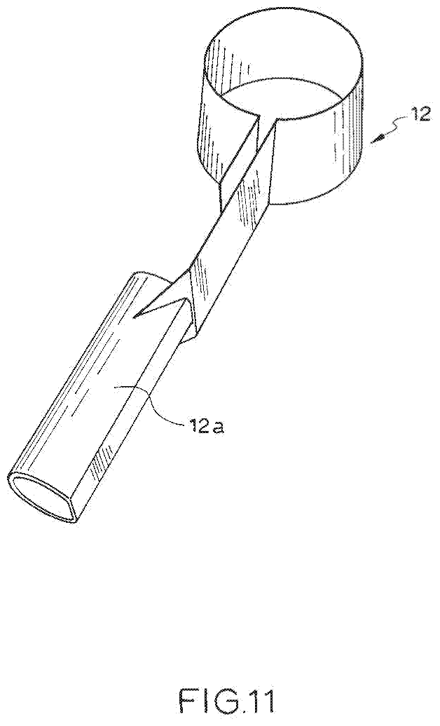

Referring now to FIGS. 9, 10a, 10b, and 11, an alternative embodiment of the present invention is shown, wherein the clamp body (2) is made from an insulating material with the same structural features as discussed above. This embodiment further includes a conductive inner sleeve (12) within the clamp body (2). The conductive inner sleeve (12) may be made of copper, brass, and other electrically conductive materials known to those skilled in the art.

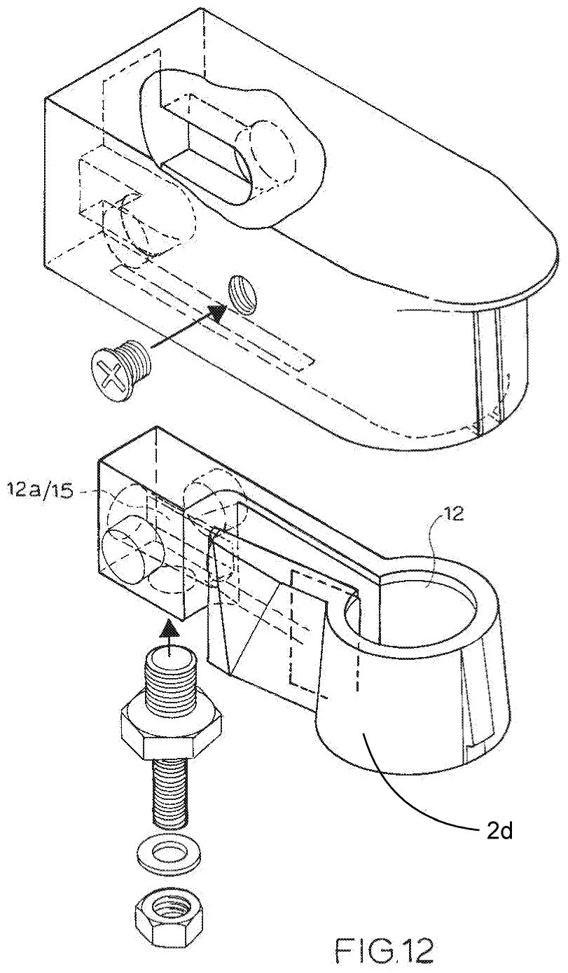

Referring now to FIG. 12, an inner section (12a) of the contact sleeve (12) is secured and clamped tightly to the lead (not shown) thereby forming direct contact between the lead and the contact sleeve (12), thus electrically connecting the lead with the contact sleeve. Either known methods of clamping or soldering, may be used, along with any other means of connecting electrically conductive components as understood by a person skilled in the art.

Referring now to FIGS. 9, 10a, 10b, 11 and 12, the contact sleeve (12) is made from a flexible and electrically conductive material to achieve optimal conductivity. One end of inner section (12a) is shaped in a substantially cylindrical shape to enable it to be slotted into the input aperture (15) of the clamp body (2) and further shaped to extend through the clamp body (2). This enables better contact between the arcuate wall of the clamp body and the battery terminal post. The contact sleeve may be manufactured from a resiliently deformable metal with spring-like characteristics to assist with reducing and expanding of the terminal post aperture of this design.

In a further embodiment, a kit for connecting a lead to a battery terminal is also envisaged. The kit comprises a battery connector according to any one of the preceding claims; a lead affixed to the battery connector; and the lead at the opposite end having an electrical attachment means affixed thereto. The electrical attachment means is also a battery connector as herein described. However, the electrical attachment means can also include alligator clips, large O-rings or C-rings, and the like as understood in the art.

Further, another kit for connecting leads to a battery terminal is also envisaged. This kit comprises: at least two battery connectors as herein described, a lead connected to each of the two battery connectors and each lead having at the opposite end an electrical attachment means affixed thereto. Each of the electrical attachment means are also battery connectors as herein described. This kit provides a pair of “jumper leads” to connect, for example, two adjacent battery terminals together. The electrical attachment means including alligator clips, clamps, large O-rings or C-rings, and other electrical attachment means as understood by the skilled person for connecting to ancillary electrical devices.

### Embodiment Two

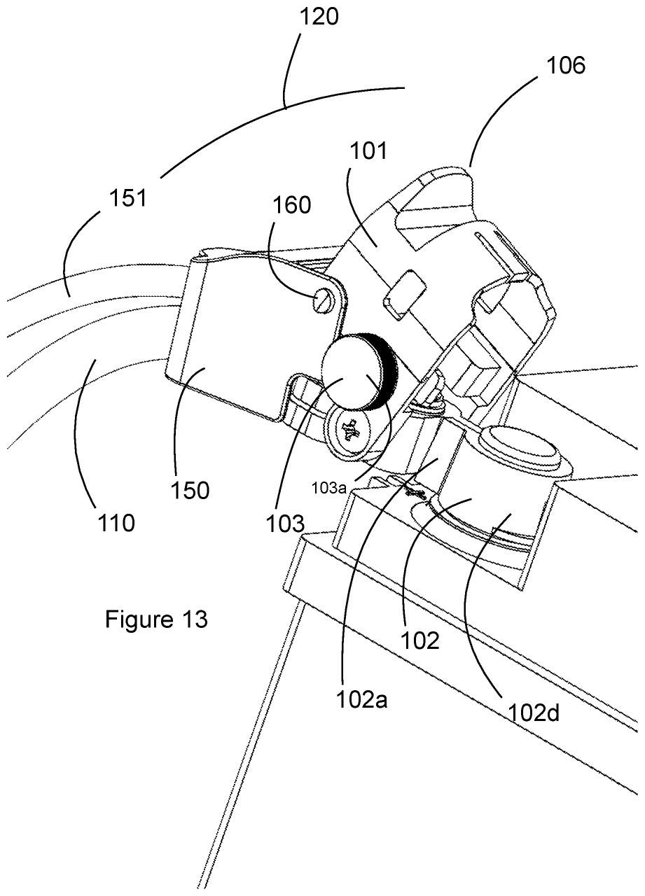

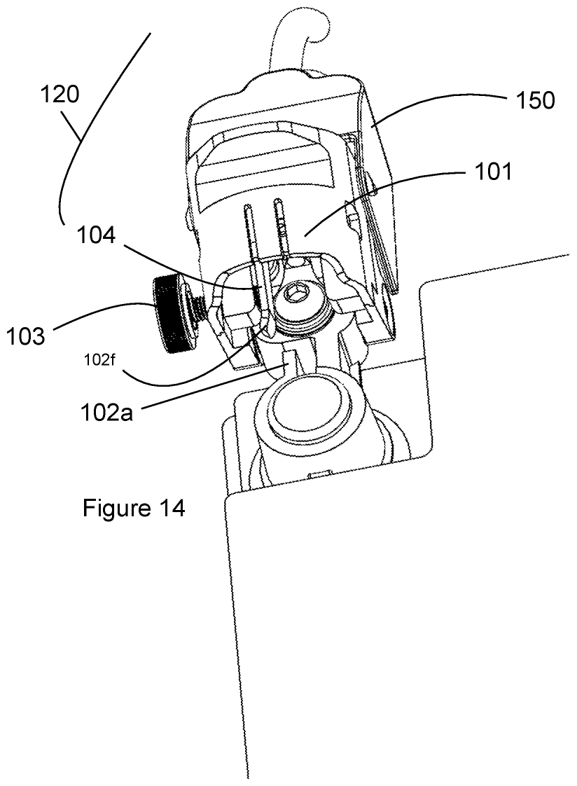

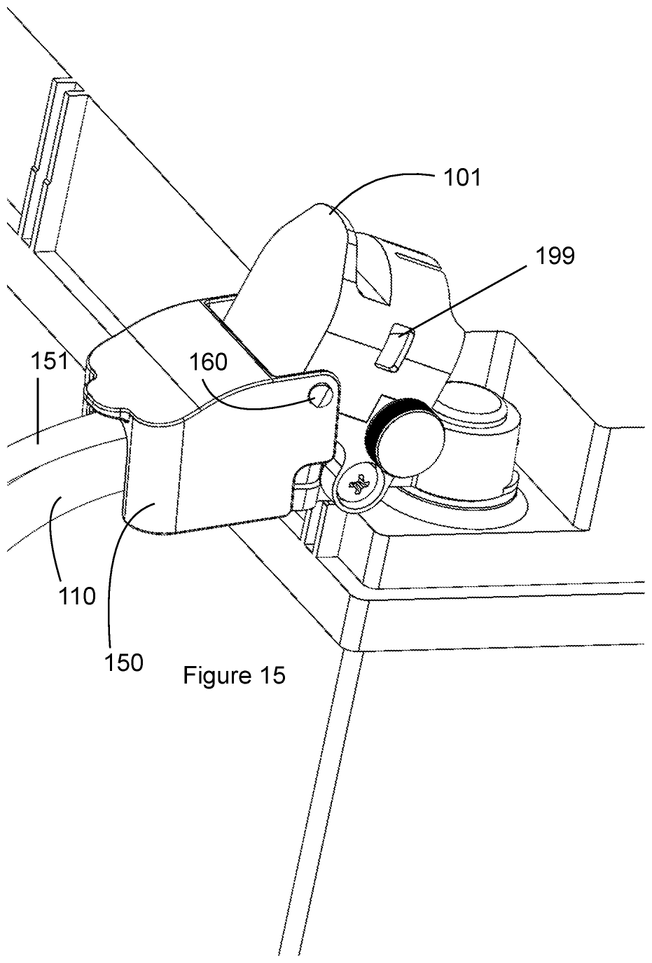

FIGS. 13 to 18 show another embodiment of battery connector which is similar in structure and operation to the embodiment shown in FIGS. 1 to 12. In FIGS. 13 to 18, parts shown that are similar to those shown in FIGS. 1 to 12, are numbered like those parts. For example, battery connector (20) in FIGS. 1 to 12 is like battery connector (120) in FIGS. 13 to 18.

One of the differences between the embodiments is that the adjustment arm (104) is not horizontal but vertical in disposition (when the cover is closed). The adjustment arm is a ramp (104a) or a flange which includes a broad surface to facilitate a strong clamping connection between the arm (104) and the leg (102) and therefore a strong clamp around the terminal post. The adjustment leg (102) is also a ramp to facilitate a strong connection between the arm (104) and the leg (102) and to facilitate a tight connection around the terminal post.

Also, the adjustment screw (103a) is a thumb screw to provide ready and toolless adjustability for the adjustment leg (104) to provide secure clamping for multiple diameter terminal posts.

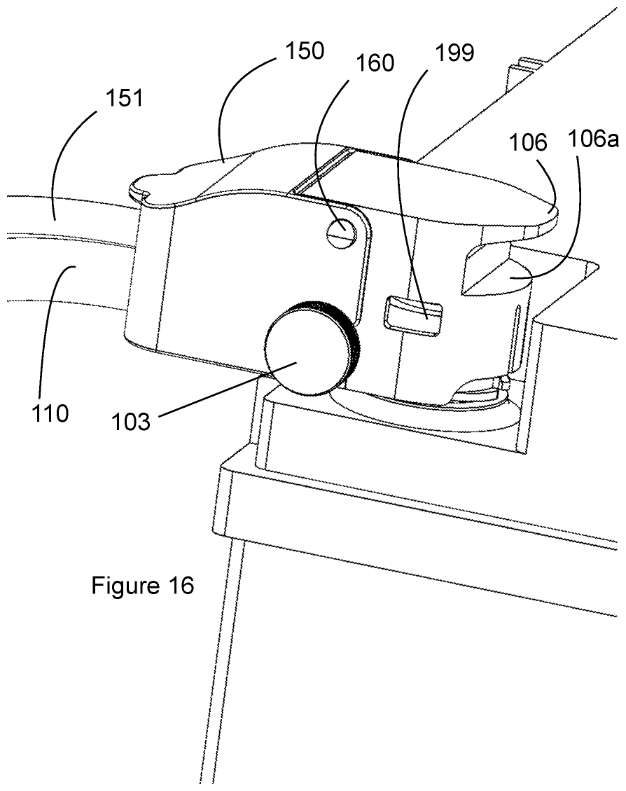

Furthermore, instead of bosses (11c and 11d) and recesses (11a and 11b), the insulating cover (101) pivots about screws (111) when it moves between the release position shown in FIGS. 13, 14 and 15, and the clamped position shown in FIGS. 16, 17 and 18.

In this embodiment there is also provided a port (199) in the side of the cover (101) to provide access for a screwdriver (not shown) for ready (tooled) release of the connector by gently prising up the cover (101) and thereby releasing the clamp (102).

Another difference between the embodiments is that the battery connector (120) in FIGS. 13 to 18 has an access closure (150) which provides access to the lead end for installing and removing one or more auxiliary leads (151) and also for inspecting the main battery lead (110) if necessary.

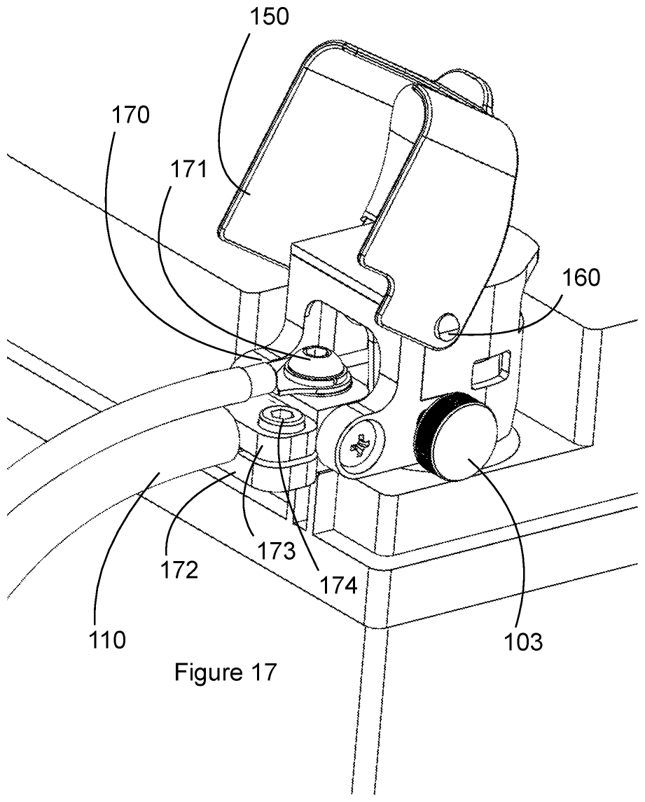

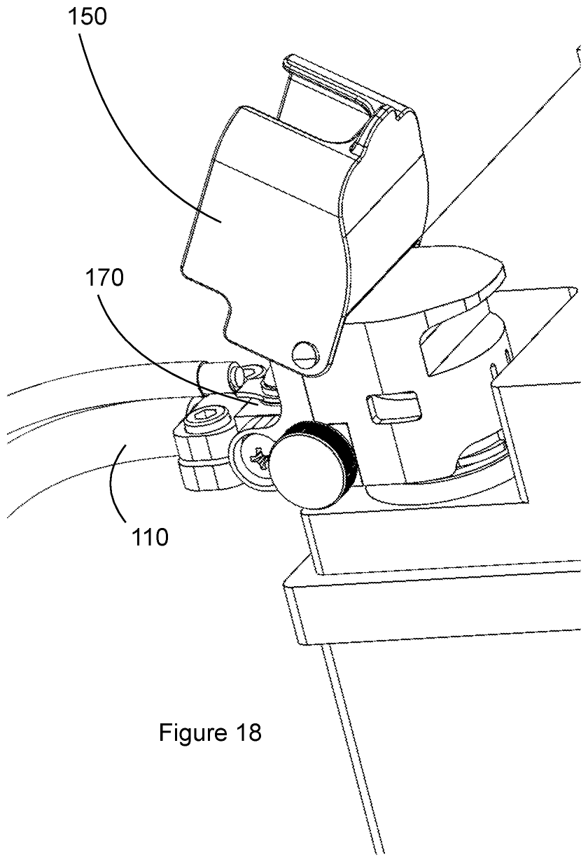

The access closure (150) is configured to swing about pivots (160) to move between the closed position shown in FIGS. 13, 15, 16 and the open position shown in FIGS. 17 and 18.

When in the open position, the access closure (150) allows access to the auxiliary lead (151) in the auxiliary lead mounting zone (170). In the auxiliary lead mounting zone (170) there is provided an auxiliary lead mounting screw (171) and a main lead mount (172). The main lead mount (172) is a main lead saddle clamp (173) and that saddle clamp (173) is held together by two saddle screws (174) to securely fasten the main lead to the clamp body (102).

Rather than, as in Embodiment One, a lip (6) extending directly from the cover (101), in Embodiment Two the extended lip (106) is disposed above a notch or recess (106a) to further assist the user in gripping the insulating cover (101) when intending to open the insulating cover (101) and disengage the connector (120). This helps to provide a stronger lip (106) and allows more force to be brought to bear on lifting the cover (101). A finger may enter the recess (106a) to provide toolless quick release.

In both embodiments it can be seen that the arcuate wall (2d, 102d) extends mostly around a periphery of a terminal post (if it were fitted around the terminal post) and the adjustment leg (2a, 102a) extends from one end of the arcuate wall. The arcuate wall (2d, 102d), then causes an aperture to open and close around the terminal post when the adjustment leg (2a, 102a) is pushed in by the clamp actuating cover (1, 101), and the size of the aperture is governed by the amount that the adjustment arm (4, 104) is adjusted by the thumb screw or other adjusting screw (3a, 103a).

There may also be provided ribs or teeth (not shown) on the inner face of the arcuate wall (2d, 102d).

The access cover (101) and access closure (150) could usefully be detachable for providing access to the lead end, or they could slide between the open and the closed positions.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that the prior art forms part of the common general knowledge in Australia. Further, the reference to any prior art in this specification is not, and should not be taken as, an acknowledgement or any form of suggestion that such art would be understood, ascertained or regarded as relevant by the skilled person in Australia.

### Advantages

The battery connector of certain embodiments provides an insulated way to connect the lead to the battery terminal post.

The battery connector of certain embodiments provides an adjustment means for fitting to different diameter battery terminal posts.

The battery connector of certain embodiments provides ready access to an auxiliary lead mount for ready electrical connection to a battery terminal.

The battery connector of certain embodiments provides quick connection to a battery terminal.

The ramps cooperate by abutting with each other over a wide surface area to provide secure clamping to terminal posts.

The adjustable ramps provide security of clamping over a range of terminal post diameters.

The thumb adjuster allows ready adjustability to various terminal diameters.

The port allows ready release of the connector from the terminal by a screwdriver or other prong or fork tine or similar, as an alternative to the extended lip (6, 106) or in the event that the extended lip (6, 106) is broken or the cover is jammed on too tightly for a finger release, or the lip (6, 106) has been rendered inaccessible.

1-36. (canceled)

37. A battery connector for a battery having a terminal post, the battery connector including a main body with a terminal clamp end and a lead end, the battery connector further comprising:
a clamp body including:
a conductive body for conducting charge from the lead end to the terminal clamp end;
a lead mount disposed at the lead end for mounting a lead;
an arcuate wall which provides a battery terminal post aperture for receiving the terminal post;
a substantially insulating clamp actuator;
an adjuster including first and second cooperating ramps, the first ramp mounted on the arcuate wall and the second ramp mounted on the clamp actuator, at least one ramp or flange being movable between a wide position and a narrow position,
wherein the clamp actuator is configured to cooperate with the clamp body to close the arcuate wall around the terminal post by a relative movement between the insulating clamp actuator and the clamp body.

38. The battery connector in accordance with claim 37 wherein upon moving the insulating actuator relative to the clamp body such that they engage with one another, the insulating actuator and clamp body are releasably secured against each other.

39. The battery connector in accordance with claim 37 wherein the adjuster ramps are disposed on adjustment flanges, adjustment legs or adjustment arms, wherein the first adjustment flange, leg, or arm is configured to interact with the cooperating adjustment flange, leg or arm through the adjustment arm biasing against the adjustment leg to adjust the diameter of the battery terminal aperture and tighten or loosen the inner clamp against the terminal post.

40. The battery connector in accordance with claim 39 wherein the variation of the inward movement of the adjustment arm changes the amount of force against the adjustment leg to allow the connector to attach to terminal posts of varying diameters.

41. The battery connector in accordance with claim 37 wherein there is provided an adjuster screw to vary an offset movement of the adjuster ramp.

42. The battery connector in accordance with claim 41 wherein the adjuster screw includes a thumb actuator to allow for toolless inward or outward adjustment of the adjustment arm.

43. The battery connector in accordance with claim 37 wherein there is provided a port or shoulder on or in the clamp actuator for facilitating lifting of the clamp actuator or clamp cover from the clamp body with a screwdriver or tool.

44. The battery connector in accordance with claim 37 wherein the clamp actuator is detachable from the clamp body to provide a quick release.

45. The battery connector in accordance with claim 37 wherein the clamp actuator is an insulating cover to inhibit user contact with the terminal.

46. The battery connector in accordance with claim 45 wherein the insulating cover is fastened to a lead end of the clamp body to allow the insulating cover to pivot between an open position and a closed position.

47. The battery connector in accordance with claim 37 wherein the adjuster includes an adjustment screw for moving one adjustment ramp inward or outward so that the adjustment ramp pushes on a cooperating adjustment ramp to adjust the terminal aperture formed by the conductive arcuate wall of the clamp body.

48. The battery connector in accordance with claim 37 wherein the insulating cover further comprises a lip on an exterior side, the lip configured to be gripped by a user to move the insulating cover between the open and closed position.

49. The battery connector in accordance with claim 37 wherein the insulating cover has an access closure constructed of an insulating material at the lead end to allow access to a lead mounting zone for mounting one or more of a main lead and one or more auxiliary leads, to allow lead connections to be made without disconnecting the clamp from the terminal post.

50. The battery connector in accordance with claim 37 wherein there is provided an auxiliary lead mounting zone at the lead end, and there is provided an auxiliary lead fastener for fastening the auxiliary lead to auxiliary lead mounting zone, which includes an auxiliary lead screw.

51. The battery connector in accordance with claim 37 wherein the access closure is pivoting or detachable to allow access to the auxiliary lead mounting zone.

52. A battery connector for connecting a lead to a terminal post of an automotive and/or mechanical battery, the battery connector including:
a connector body including a terminal end and a lead end, the connector body including:
a clamp at the terminal end for clamping to the terminal post, the clamp including a conductive arcuate wall to provide a terminal post aperture adjustable in size for clamping substantially around the terminal post;
an auxiliary lead mounting zone disposed at the lead end for mounting one or more auxiliary leads,
wherein there is a lead end closure formed of an insulating material for controlling access to the auxiliary lead end for connecting and disconnecting the one or more auxiliary leads without disconnecting the connector from the terminal post.

53. The battery connector in accordance with claim wherein the access closure is pivoting or detachable for providing access to the auxiliary lead mounting zone.

54. The battery connector in accordance with claim 52 wherein there is further provided an adjuster for adjusting the size of the terminal post aperture.

55. The battery connector in accordance with claim 52 wherein the adjuster includes an adjustment leg extending from a portion of the arcuate wall, the adjustment leg movable between a narrow position in which the terminal post aperture is smaller to clamp the arcuate peripheral wall snugly against small diameter terminal posts, to a wide position in which the terminal post aperture is larger such that the arcuate wall clamps snugly against larger diameter terminal posts.

56. A kit for connecting a lead to a battery terminal comprising: a battery connector in accordance with claim 37; a lead affixed to the battery connector; and the lead at the opposite end having an electrical attachment means affixed thereto.
